(19) United States
(12) Patent Application Publication
(10) Pub. No.: US 2020/0022469 A1
(43) Pub. Date: Jan. 23, 2020

(54) POWERED LIGHT-UP BEAD AND ASSEMBLY FOR USE IN JEWELRY

(71) Applicant: Aaron Alstrom, Corona, CA (US)

(72) Inventor: Aaron Alstrom, Corona, CA (US)

(21) Appl. No.: 16/515,292

(22) Filed: Jul. 18, 2019

Related U.S. Application Data
(60) Provisional application No. 62/700,490, filed on Jul. 19, 2018.

(51) Int. Cl. A44C 15/00; A44C 5/20; A44C 5/00

(52) U.S. Cl. CPC A44C 15/0015; A44C 15/005; F21Y 2115/10; A44C 5/0007; A44C 15/0085; A44C 5/20

(57) ABSTRACT

A powered light-up bead and assembly for use in jewelry items. The assembly forming a bracelet that can be adapted to several alternate types, embodiments, and styles of jewelry, including, but not limited to, necklaces, bracelets, anklets, and other similar ring or hoop-like assemblies having a length and a clasp for the coupling of a pair of opposed ends around a circumference. The assembly is configured for illumination from an interior space or cavity of a bead and having a resilient connecting portion between adjacent beads.

### CROSS-REFERENCE TO RELATED APPLICATION

This patent application claims priority to U.S. Provisional Application 62/700,490 filed Jul. 19, 2018 to the above-named inventor, the disclosure of which is considered part of the disclosure of this application and is hereby incorporated by reference in its entirety.

### FEDERALLY SPONSORED RESEARCH OR DEVELOPMENT

Not Applicable SEQUENCE LISTING, A TABLE, OR A COMPUTER PROGRAM

Not Applicable

### FIELD OF THE INVENTION

The invention relates generally to a powered light-up bead and assembly for a plurality of beads for use in jewelry items, such as a bracelet.

### BACKGROUND

Within the prior art there currently exists some types of illuminated jewelry. Most often, this illuminated jewelry, commonly referred to, as a glow-stick, utilizes a chemical composition to produce a glowing effect. Generally, this chemical composition fails to meet the needs of the market because the composition only illuminates for a few hours.

An additional type of illuminated jewelry item utilizes a traditional bulb that is arranged as a charm or lighted hanging item affixed to a more traditional jewelry item. This type of lighted jewelry item is similarly unable to meet the needs of the market because often these lights or charms are too distracting and generally take away from the overall appearance of the jewelry.

### SUMMARY OF THE INVENTION

The device of the present disclosure is most generally described as a lighted beaded jewelry item configured with a structural assembly that illuminates beads from within an interior space or cavity for use in a variety of jewelry items. The device includes a clasp member, a power source, a plurality of beads, a connecting portion, and a light source.

In the preferred assembly of the present disclosure, the light source is a light emitting diode (LED) and the power source is a removable battery. The device is most generally configured for use in jewelry items that are configured with a length having a pair of ends in a removable coupling to form a circumference sized for wearing. Accordingly, the device is most generally used a bracelet, anklet, or necklace.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 shows the top of the device, according to the present disclosure;

FIG. 2 shows the right-side view of the device, according to the present disclosure;

FIG. 3 shows a perspective view of the device, according to the present disclosure;

FIG. 4 shows the left side view of the device, according to the present disclosure;

FIG. 5 shows the front of the device, according to the present disclosure;

FIG. 6 shows the bottom of the device, according to the present disclosure;

FIG. 7 shows the back of the device, according to the present disclosure; and

FIG. 8 shows a perspective view of an alternate embodiment of the device with a snap closure, according to the present disclosure.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s or step(s, to the objective(s, spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being in communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The invention is most generally a powered light-up bead and assembly for use in a beaded jewelry item.

According, the device is configured for illumination from within an interior structure and includes a plurality of cooperative components to form a unique item of jewelry.

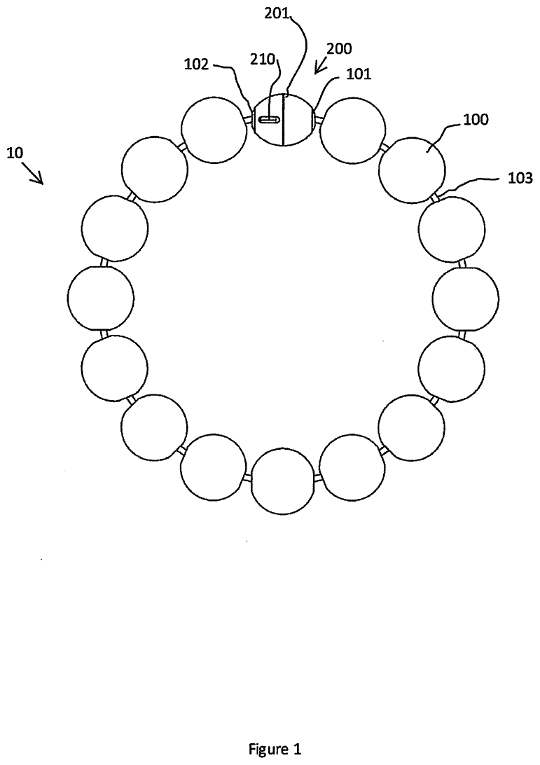

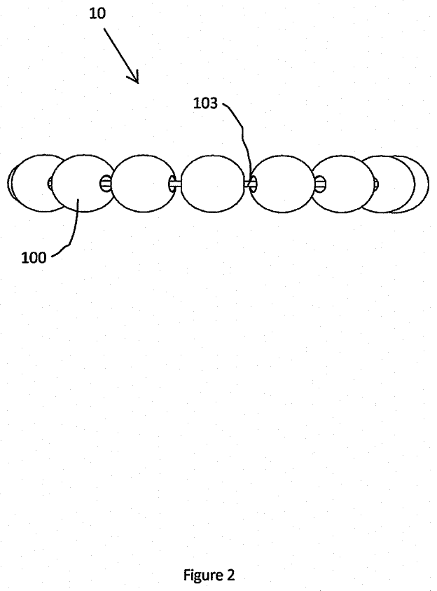

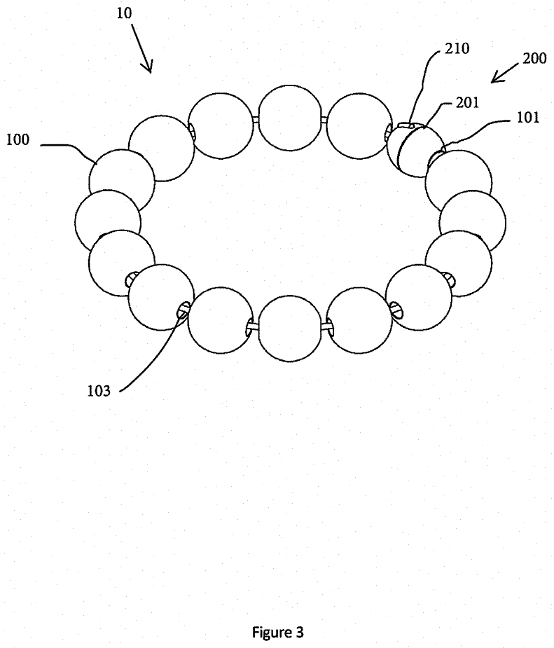

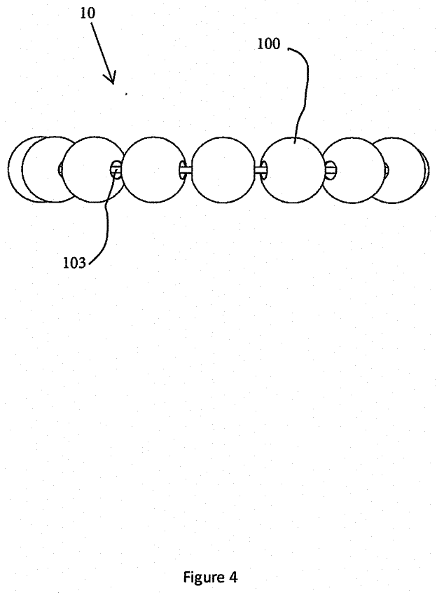

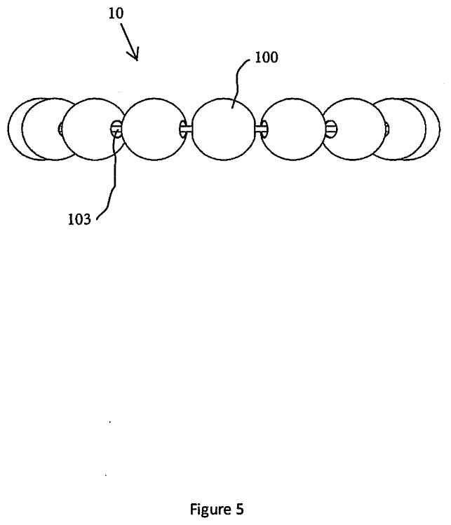

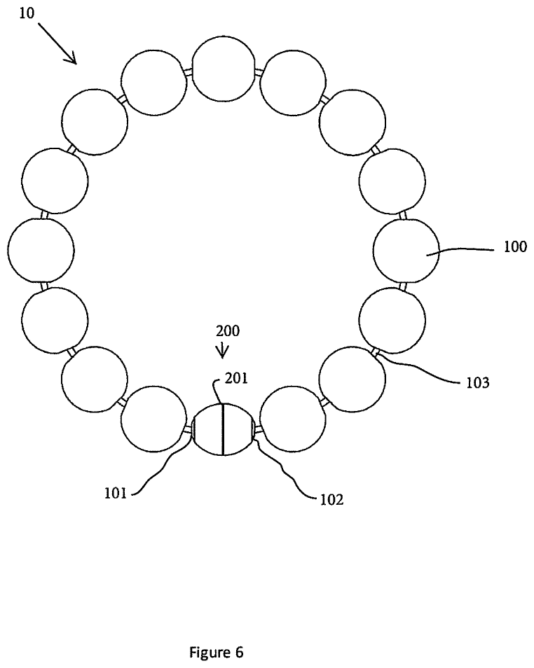

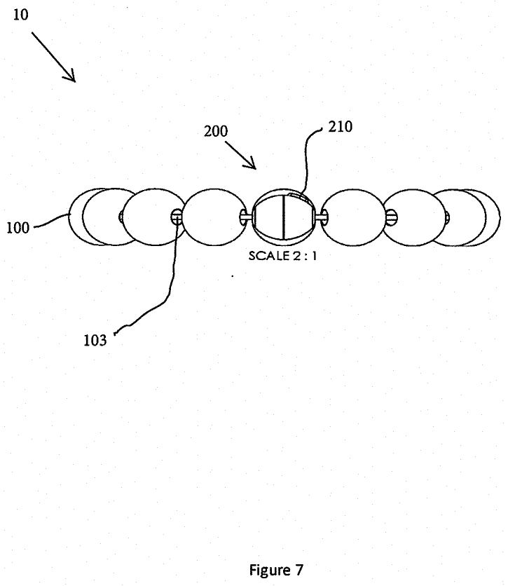

Referring now specifically to the figures, FIG. 1 to FIG. 8 show a powered light-up bead and assembly for use in jewelry items, generally referred to as device 10. The device 10 within the included figures is most generally depicted as a bracelet. Although a bracelet is depicted, the device 10 teachings and disclosure can be adapted to several alternate types, embodiments, and styles of jewelry, including, but not limited to, necklaces, bracelets, anklets, and other similar ring or hoop-like assemblies having a length and a clasp 200 for the coupling of a pair of opposed ends 101, 102 of the length around a circumference.

The device 10 structural assembly is configured for illumination from an interior space or cavity of a cylindrical structure, herein referred to as a bead 100. Accordingly, the device 10 includes a plurality of beads 100 having a structural assembly with a housing substantially enclosing an interior cavity and arranged in an adjacency across the device 10 length culminating in the first end 101 opposite the second end 102, wherein the distance between the first end 101 and the second end 102 defines the length of the device 10. The housing of each bead 100 of the plurality of beads 100 comprised of an at least translucent material, wherein a light source placed and supported within the bead 100 interior will be visible from an exterior of the housing. The translucent material of the housing can be tinted, colored, or transparent to present both a colored and non-colored jewelry item. The light source is comprised of a light emitting diode (LED). The LED may be colored or non-colored.

The device 10 including a connecting portion 103 generally forming both a structural and an electronic coupling between adjacent beads 100 of the plurality of beads 100. The connecting portion 103 being a resilient member with flexible, elastic-like, properties enabling stretching of the connecting portion 101 between the adjacent beads 100. Accordingly, the connecting portion 103 wire configured to conduct a current and function as a wire for distributing power throughout the device 10.

The first end 101 and the second end 102 of the device 10 coupled together through the clasp 200. The clasp 200 configured to power the device 10 through coupling with a power source, such as an encapsulated battery, and a switch 210. The switch 210 directed to operate the features and functions of the device 10, including, but not limited to, powering the device 10 on and off. Preferably, the clasp 200 is shaped to resemble a bead 100, wherein a pair of halves are fitted together at a central position 201 to secure the device 10 to a wearer, such as through a threaded connection. The clasp 200 may further included various circuits and controllers to direct illumination of the LED light source within the beads 100, wherein the controller may direct the illumination patterns and colors of the LED within the housing of a bead 100 of the plurality of beads 100.

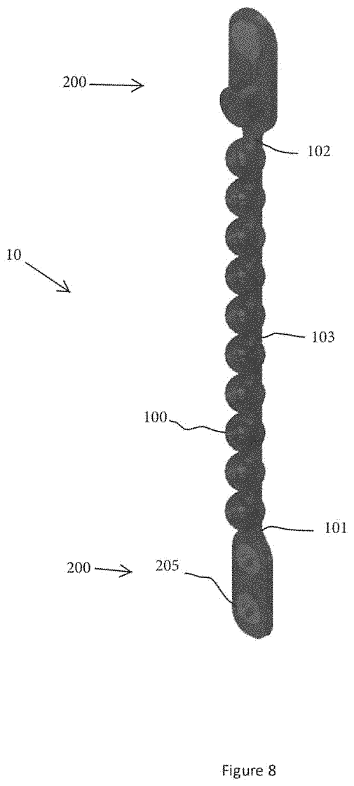

In an alternate assembly of the device 10 as shown in FIG. 8, the clasp 200 is comprised of at least one snap 205 configured for receipt within a complementary socket for securing the device 10 around the wearer. The at least one snap 205 functioning as a button-style fastener and having conductive properties in the coupling, wherein the at least one snap 205 completes a circuit of the device enabling operation of the device during engagement.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

1. An illuminated jewelry item, the jewelry item
a first end; comprising:
a second end opposite the first end, the distance between the first end and the second end defining a length of the jewelry item;
a plurality of beads, each bead of the plurality of beads having a light source;
a connecting portion, the connecting portion coupled to the first end, the second end, and the plurality of beads;
a clasp, the clasp removably securing the first end and the second end; and
a power source, the source coupled to the connecting portion for illuminating the light source.

2. An illuminated jewelry item as in claim 1, wherein the jewelry item is a bracelet.

3. An illuminated jewelry item as in claim 1, wherein the jewelry item is a necklace.

4. An illuminated jewelry item as in claim 1, wherein the jewelry item is an anklet.

5. An illuminated jewelry item as in claim 1, wherein the clasp is threaded.

6. An illuminated jewelry item as in claim 1, wherein the clasp is a snap fastener.

7. An illuminated jewelry item as in claim 1, wherein the light source is a light emitting diode.

8. A jewelry item, the jewelry item comprising: a first end;
a second end opposite the first end extending a distance, the distance between the first end and the second end defining a length of the jewelry item;
a plurality of beads, at least one bead of the plurality of beads having a light source;
a connecting portion, the connecting portion resilient and coupled to the first end, the second end, and the plurality of beads;
a clasp, the clasp removably securing the first end and the second end; and
a power source, the source coupled to the connecting portion for illuminating the light source.

9. A jewelry item as in claim 8, wherein the jewelry item is a bracelet.

10. A jewelry item as in claim 8, wherein the jewelry item is a necklace.

11. A jewelry item as in claim 8, wherein the jewelry item is an anklet.

12. A jewelry item as in claim 8, wherein the clasp is threaded.

13. A jewelry item as in claim 8, wherein the clasp is a snap fastener.

14. A jewelry item as in claim 8, wherein the light source is a light emitting diode.

15. A jewelry item, the jewelry item comprising:
a first end;
a second end opposite the first end extending a distance, the distance between the first end and the second end defining a length of the jewelry item;
a plurality of beads, the plurality of beads having an interior space defining a cavity, at least one bead of the plurality of beads having a light source comprised of a light emitting diode within the interior space;
a connecting portion, the connecting portion resilient and coupled to the first end, the second end, and the plurality of beads;
a clasp, the clasp removably securing the first end and the second end; and
a power source, the source coupled to the connecting portion for illuminating the light source.

16. A jewelry item as in claim 15, wherein the jewelry item is a bracelet.

17. A jewelry item as in claim 15, wherein the jewelry item is a necklace.

18. A jewelry item as in claim 15, wherein the clasp is threaded.

19. A jewelry item as in claim 15, wherein the clasp is a snap fastener.

20. A jewelry item as in claim 15, wherein the power source is encapsulated.
